(19) United States
(12) Patent Application Publication
(10) Pub. No.: US 2005/0231351 A1
(43) Pub. Date: Oct. 20, 2005

(54) Switchgear cabinet monitoring system

(76) Inventors: Jorg Kreiling, Biebertal (DE); Sven Laurosch, Haiger (DE)

Correspondence Address: Pauley Petersen Kinne & Erickson, 2800 W Higgins Road, Suite 365, Hoffman Estates, IL, 60195, US

(21) Appl. No.: 10/466,617

(22) PCT Filed: Apr. 17, 2002
(86) PCT No.: PCT/EP02/04234

§ 371 Date: Jul. 18, 2003

(30) Foreign Application Priority Data
Apr. 20, 2001 (DE) 101 19 637.7

(51) Int. Cl. G08B 19/00

(52) U.S. Cl. 340/521

(57) ABSTRACT

A switchgear cabinet monitoring system that is designed for monitoring functions, which pertain to the switchgear cabinet itself, including temperature control, and has a centralized monitoring unit as well as at least one decentralized unit, which is in data transmission contact with or can be brought into data transmission contact with the monitoring unit via a data transmission link and which is assigned to a respective function or function group having similar functions. This invention provides a switchgear cabinet monitoring device that can be variably constructed at a relatively low cost. The centralized monitoring unit is provided as a main unit having at least one standardized interface for carrying out a wireless data transmission. In addition, the data transmission link has at least one wireless transmission link, and the at least one decentralized unit also has at least one standardized additional interface, which is adapted to the interface of the main unit and which carries out wireless transmission.

### BACKGROUND OF THE INVENTION

1. Field of the Invention

This invention relates to a switchgear cabinet monitoring system, which is designed for monitoring functions relating to the switchgear cabinet itself, including temperature regulation, and which has a central monitoring unit, and at least one decentralized unit, which is or can be brought into connection with the central monitoring unit for data transmissions over a data transmission link and is assigned to a respective function, or a functional group of identical functions.

2. Discussion of Related Art

A switchgear cabinet monitoring system of this type is taught by PCT International Publication WO 97/34345. In this known switchgear cabinet monitoring system, which is laid out for monitoring functions relating to the switchgear cabinet itself, including an air conditioning arrangement, various components for the detection of signals and controlling actuators are connected to a central monitoring unit via a data transmission link. The components include an input interface for connecting various sensors, such as humidity sensors, door limit stop switches, temperature sensors, vibration sensors, smoke detectors, transducers and temperature sensors, a regulating and control interface for air conditioning components, such as heat exchangers, exhaust fans, cooling apparatus, heaters, an outlet connector unit for connecting a relay, opto-coupler, bus system, telemetry installation, PC interface connection for analog signals and a display unit. A connection for a programming and test device and a control station are also provided. The connection of the various components results in a relatively large cost.

For reducing the cost German Patent Reference 101 08 599 discloses a server switching device housed in the switchgear cabinet, or the switchgear cabinet arrangement, for configuration and visual checking by an operator so that its display control device, including the display device, is also used for the monitoring unit, for which purpose the monitoring unit is connected to the respective server switching device.

A switchgear cabinet monitoring device is taught by German Patent Reference 101 13 626.9 wherein vital functions of a server are monitored by the switchgear cabinet monitoring device, and a connection is made between the switchgear cabinet monitoring device and a monitoring module, which is already assigned to the server.

A switchgear cabinet monitoring system is taught by German Patent Reference DE 199 11 249 A1. With this known switchgear cabinet monitoring system, sensors can be connected to a central monitoring system via respective inputs, and actuators via respective outputs.

In a monitoring system taught by PCT International Publication WO 98/39718, for monitoring machinery, local monitoring units, connected to the machinery, are connected via at least one standardized interface, which can also be wireless, with a global processor for exchanging data.

### SUMMARY OF THE INVENTION

One object of this invention is to provide a switchgear cabinet monitoring system of the type mentioned above but wherein the installation and retrofitting options are simplified.

This object is attained with a central monitoring unit as the main unit which has at least one standardized interface for wireless data transmission. The data transmission link comprises at least one wireless transmission link, and the at least one decentralized unit also has at least one standardized further interface matched to the interface of the main unit for wireless transmission. The design of the monitoring system as a main unit (master device), in particular is placed into a housing, and at least one decentralized unit, is brought into a data transmission connection with the main unit via the wireless transmission link result, without elaborate cable connections, in multiple arrangement possibilities for the compact decentralized housing, is preferably placed into its own housing, and can also be replaced and retrofitted in a simple way, as desired. Equipping the main unit and the decentralized units with the standardized interface, or the standardized further interface, is easily accomplished, for example by using appropriate modules. For example, an interface, presently known as blue tooth, is suitable for establishing the standardized transmission link. In this case the main unit and the decentralized unit can be placed into the same switchgear cabinet, or for example also into lined-up switchgear cabinets, or in an arrangement of switchgear cabinets which are separated from each other and are located within the range of the data transmission link, for example inside a building complex, a building or a room.

If the design has several decentralized units, each with identical further interfaces, and the data transmission from and to the main unit takes place via an interface for wireless data transmission, it is possible for the various decentralized units to exchange data with the main unit via only one interface.

In different embodiments, the wireless transmission link is a radio link, an infrared link or an ultrasound link.

For example, in one embodiment of the monitoring system the decentralized units comprise a sensor connection unit, a door control unit, an air conditioning unit, an operating unit, an energy supply unit or an adapter unit, or a combination of at least two of these units, wherein several of the same units can also be provided. A simple coupling possibility is provided by the adapter unit, by which devices which do not have an appropriate interface such as the main unit, can exchange data with the main unit. This is possible because the adapter unit has still further wireless or wire-connected connecting points for a connection with further devices.

In order to offer additional expansion options, at least the main unit also has at least one wire-connected transmission interface for a connection with further decentralized units, which have further wire-connected interfaces, and a managing unit, by which the decentralized units and, if required, the possibly existing further decentralized units, are managed. In this case the wire-connected transmission link is embodied as a bus link, for example, through which several decentralized devices can be connected with the main unit.

A control option from a remote station is possible because the main unit has a network interface for wire-connected or wireless network access.

The network can be an internal installation facility or a public network.

The communication possibility when installing the main unit and decentralized units in different switchgear cabinets is enhanced because the main unit and/or at least a part of the decentralized units can be connected with remote transmission and receiving units, which can be installed in the area of or near a cabinet wall.

The cost in connection with the arrangement in a server cabinet is kept low when the main unit has a wireless or wire-connected connecting point for creating a data transmission with a server switching device.

In one embodiment the main unit can be controlled and/or configured via a visual display assigned to the server switching device by an assigned visual display control of the server switching device, and the main unit is embodied for interrogating and evaluating data for vital server functions picked up by a service monitoring module assigned to a server.

In another embodiment, there is a monitoring system included in a switchgear cabinet or in a switchgear monitoring device.

The term switchgear cabinet used in connection with this specification should be understood to be a general term, which also relates to server cabinets or other cabinets in connection with information technology in the interior area and the exterior area.

### BRIEF DESCRIPTION OF THE DRAWINGS

This invention is explained in greater detail in view of embodiments and by reference to the drawings, wherein:

FIG. 1 is a switchgear cabinet monitoring system in a schematic block diagram, and

FIG. 2 is a switchgear cabinet arrangement in a schematic block diagram, with a switchgear cabinet monitoring system in accordance with FIG. 1.

### DESCRIPTION OF PREFERRED EMBODIMENTS

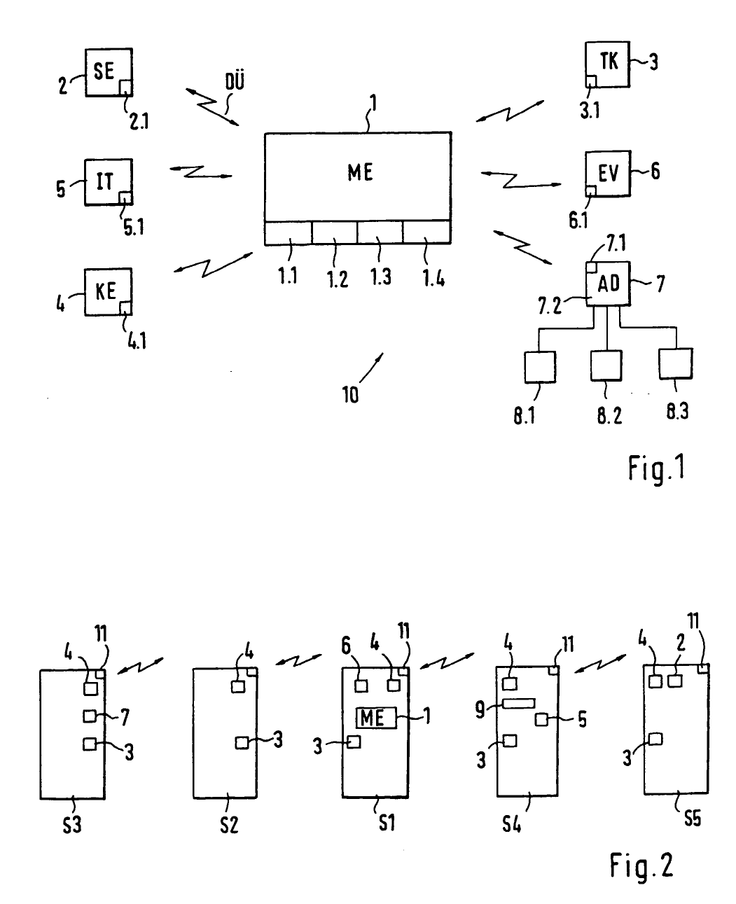

A switchgear cabinet monitoring system 10 shown in FIG. 1 has as a central monitoring unit a main unit 1, a master device, with several transmission interfaces 1.1 to 1.4, and several decentralized units, including a sensor connection unit 2, a door control unit 3, an air conditioning control unit 4, an operating unit 5, an energy supply unit 6 and an adapter unit 7, to which further devices 8.1, 8.2, 8.3 are or can be connected via wireless or wire-connected connecting points 7.2 provided thereon. The decentralized units relate to functions regarding the switchgear cabinet itself and are managed by the main unit 1 and can also be controlled by it as a function of programs which are or can be predetermined in the managing unit and in which data, provided by the respective and/or other decentralized units, are taken into consideration. For data transmission, the transmission interfaces 1.1 to 1.4 have at least one standardized interface for a wireless data transmission, for example in accordance with the blue tooth standard. The decentralized units 2 to 7 have appropriate further standardized wireless interfaces 2.1 to 7.1, so that an unequivocal, dependable data transmission is assured. The transmission interfaces of the main unit 1 also include, for example, wire-connected transmission interfaces 1.2, 1.3, and a wireless or wire-connected network interface 1.4 for data transmission via a local, internal installation or public network, and communication with a remote station, wherein copper or fiber-optical lines are parts of the wire-connected data transmission link.

With this layout, all decentralized units 2 to 7 can be monitored and/or controlled by the main unit 1, for example via the blue tooth data transmission link, via the ether net, or via an I²C link. The reports from the individual decentralized units 2 to 4 can be collected and passed on by a simple data transmission protocol, for example SNMP, via e-mail, or other transmission methods, or can also be output at the operating unit 5, for example on an appropriate visual display. If required, it is also possible for an operator to take action via these routes.

Appropriate sensors, such as taught by PCT International Publication WO 97/34345 can be connected to the sensor connection unit 2 by digital inputs, analog inputs, a frequency input, or other universal inputs in the sensor connection unit 2, wherein an automatic sensor recognition can also be provided in the sensor connection unit 2. In that case the sensor connection unit 2 can formulate appropriate preliminary information and pass it on to the main unit 1. An access control unit, for example by a code card, a transponder, or similar authorization control unit, is integrated into the door control unit 3, wherein the access control unit can be mounted directly on the cabinet, or can be performed via a hand-held device, which then itself has a standardized interface for wireless communications with the main unit 1.

The air conditioning unit 4 can also have similar functions as mentioned in the above identified printed document. Thus, different air conditioning components can be suitably triggered in accordance with a predetermined, or predeterminable air conditioning concept. Electrical power supply monitoring, as well as a control and monitoring of the exhaust fans, control and/or regulation of the further air conditioning components, wherein data which are developed or stored in the air conditioning control unit 4 can be transmitted by it to the main unit 1 and can be transmitted to the air conditioning components.

Cabinet parameters can be displayed, and changes can also be made by the operating unit 5, which also has a visual display, for example in the form of a CWT display. Acoustic reports can also be input or output at the operating unit 5. An advantageous operation is made possible with a touch-screen function.

The energy supply unit 6 comprises an intelligent socket strip, by which current, voltage and/or output can be monitored and, for example, it is also possible to determine the costs for the connected users. The individual connector sockets can be automatically switched by a real time clock provided therein. Also, the further monitoring and control options mentioned in the above identified printed document in connection with the energy supply are also possible.

Further devices, for example which are not equipped with an appropriate transmission interface and which have an RS232 interface, for example, can be inserted into the monitoring system via the adapter unit 7. These devices can be placed in a simple manner into a data transmission connection with the main unit 1 via the adapter unit 7.

The switchgear cabinet monitoring system 10 so far described can be arranged in only one switchgear cabinet, or in a group of lined-up switchgear cabinets, wherein the main unit 1 and the decentralized units 2 to 7 can be arranged at suitable locations.

However, as FIG. 2 shows, the main unit 1 and the decentralized units 2 to 7 can be arranged in separate switchgear cabinets S1 to S5, wherein a single main unit 1 is sufficient for the entire switchgear cabinet arrangement, and decentralized units 2 to 7 can be arranged in various numbers and arrangements depending on their monitoring task and monitoring function in the various switchgear cabinets S1 to S5. For assuring a dependable wireless data transmission between the various units 1 to 7 of the monitoring system among the switchgear cabinets S1 to S5, it is advantageous for transmitting/receiving units 11 to be arranged at suitable locations in the switchgear cabinets S1 to S5, which make possible the transmission and reception of the date transmitted in a wireless manner between the separate switchgear cabinets. The various units 1 to 7 can be simply connected with the transmitting/receiving units 11 by appropriate connectors. For example, if a wireless transmission by the blue tooth standard is realized, the switchgear cabinets can be arranged at a respective distance of up to 100 meters from each other.

The monitoring system 10 is also designed so that it can be connected, for example to a server switching device 9, either in a wireless or a wire-connected manner in order to make use of a visual display and visual display control assigned to the server switching device 9 for representing information and for the configuration of the main unit 1. The main unit 1 can also be connected via the server switching device 9, or also direct, with a monitoring module of a server or of another computing unit in order to monitor its or their vital functions.

A versatile switchgear cabinet monitoring system 10, which can be assembled with a relatively small outlay, is possible with this invention.

1. A switchgear cabinet monitoring system (10) for monitoring functions relating to the switchgear cabinet, including a temperature regulation, and having a central monitoring unit and at least one decentralized unit (2 to 7), which is or can be brought into connection with the central monitoring unit for data transmissions over a data transmission link (DÜ) and is assigned to a respective function or a functional group of identical functions, the monitoring system (10) comprising:
the central monitoring unit being a main unit (ME) with at least one standardized interface (1.1) for a wireless data transmission,
the data transmission link (DÜ) comprising at least one wireless transmission link, and
the decentralized units (2 to 7) having a standardized interface (2.1 to 7.2) matched to the interface (1.1) of the main unit (ME) for wireless transmission, each identically designed, and
the data transmissions from and to the main unit (ME) occurring via an interface (1.1) of the main unit (ME) for wireless data transmission.

2. The monitoring system in accordance with claim 1, wherein
the at least one wireless transmission link is one of a radio link, an infrared link and an ultrasound link.

3. The monitoring system in accordance with claim 2, wherein
the decentralized units comprise at least one of a sensor connection unit (2), a door control unit (TK), an air conditioning unit (4), an operating unit (IT), an energy supply unit (6) and an adapter unit (7).

4. The monitoring system in accordance with claim 3, wherein
the adapter unit (7) has one of wireless and wire-connected connecting points (7.2) for a connection with further devices (8.1, 8.2, 8.3).

5. The monitoring system in accordance with claim 4, wherein
at least the main unit (ME) has at least one wire-connected transmission interface (1.2, 1.3) for a connection with the decentralized units, which have wire-connected interfaces, and a managing unit (VE) by which the decentralized units (2 to 7) and, as required, the decentralized units are managed.

6. The monitoring system in accordance with claim 5, wherein
the main unit (ME) has a network interface (1.4) for the one of the wire-connected and wireless network access.

7. The monitoring system in accordance with claim 6, wherein at least one of
the main unit (1) and at least a part of the decentralized units (2 to 7) is connectible with remote transmission and receiving units (11).

8. The monitoring system in accordance with claim 7, wherein
the main unit (1) has one of a wireless and a wire-connected connecting point for creating a data transmission with a server switching device.

9. The monitoring system in accordance with claim 8, wherein
the main unit (1) is at least one of controlled and configured via a visual display assigned to the server switching device by an assigned visual display control of the server switching device (9).

10. The monitoring system in accordance with claim 9, wherein
the main unit (1) interrogates and evaluates data for a vital server function picked up by a service monitoring module assigned to a server.

11. The monitoring system (1) in accordance with claim 10, wherein the monitoring system (1) is received in the switchgear cabinet.

12. The monitoring system in accordance with claim 1, wherein the decentralized units comprise at least one of a sensor connection unit (2), a door control unit (TK), an air conditioning unit (4), an operating unit (IT), an energy supply unit (6) and an adapter unit (7).

13. The monitoring system in accordance with claim 12, wherein the adapter unit (7) has one of wireless and wire-connected connecting points (7.2) for a connection with further devices (8.1, 8.2, 8.3).

14. The monitoring system in accordance with claim 1, wherein at least the main unit (ME) has at least one wire-connected transmission interface (1.2, 1.3) for a connection with the decentralized units, which have wire-connected interfaces, and a managing unit (VE) by which the decentralized units (2 to 7) and, as required, the decentralized units are managed.

15. The monitoring system in accordance with claim 1, wherein the main unit (ME) has a network interface (1.4) for the one of the wire-connected and wireless network access.

16. The monitoring system in accordance with claim 1, wherein at least one of the main unit (1) and at least a part of the decentralized units (2 to 7) is connectible with remote transmission and receiving units (11).

17. The monitoring system in accordance with claim 1, wherein the main unit (1) has one of a wireless and a wire-connected connecting point for creating a data transmission with a server switching device.

18. The monitoring system in accordance with claim 17, wherein the main unit (1) is at least one of controlled and configured via a visual display assigned to the server switching device by an assigned visual display control of the server switching device (9).

19. The monitoring system in accordance with claim 8, wherein the main unit (1) interrogates and evaluates data for a vital server function picked up by a service monitoring module assigned to a server.

20. The monitoring system (1) in accordance with claim 1, wherein the monitoring system (1) is received in the switchgear cabinet.
